(19) United States
(12) Patent Application Publication
(10) Pub. No.: US 2009/0066518 A1
(43) Pub. Date: Mar. 12, 2009

(54) ID TAG PACKAGE AND RFID SYSTEM

(75) Inventors: Hidekazu Tanaka, Kanagawa (JP); Kaoru Fukuda, Kanagawa-ken (JP); Hiroyuki Takenoshita, Kanagawa-ken (JP)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/913,796

(22) PCT Filed: May 23, 2006
(86) PCT No.: PCT/JP2006/310222

§ 371 Date: Nov. 7, 2007

(30) Foreign Application Priority Data
May 25, 2005 (JP) 2005-151724

(51) Int. Cl. G08B 13/14

(52) U.S. Cl. 340/572.8

(57) ABSTRACT

Embodiments of the present invention provide an ID tag package including a structure covering an ID tag therein. The structure has a thickness necessary for reducing attenuation of electromagnetic wave caused by existence of metal or water external to the ID tag, and includes at least an elastic layer enabling reduction of external stresses. An RFID system using the package is also provided.

### CROSS-REFERENCE TO RELATED APPLICATIONS

The present application claims priority of an international patent application S/N PCT/JP2006/310222, entitled “ID Tag Package and RFID System”, filed May 23, 2006, which in turn claims priority of a Japanese patent application S/N 2005-151724 filed May 25, 2005.

### FIELD OF THE INVENTION

The present invention relates to a non-contact identification technology using an electromagnetic wave, and particularly, relates to a packaging technology for a tag being attached to an object to be identified.

### BACKGROUND

Radio Frequency Identification (RFID) is a technology by which an electromagnetic wave is transmitted from an interrogator (reader and/or writer) to an RF tag, which may be attached to an object for identification the of the object, and ID information of the object is read and/or written without the object being contacted. An RF tag of card type such as a train commuter ticket is now being widely used. It is also expected that RF tags that are smaller, stronger, and more durable will be used in future for tracing products, machines, etc.

An RF tag may be referred to as an ID tag or IC tag (hereinafter, it is called an ID tag). An ID tag usually includes an IC chip and an antenna for radio communication. Many ID tags generally do not include therein batteries used for waking up purpose. When no battery is included, the IC chip in the ID tag receives an electromagnetic wave from an external reader and/or writer and is woken up by the energy of the electromagnetic wave. In order to communicate with the reader and/or writer, it is necessary that the electromagnetic wave that the ID tag receives has an energy level that is sufficient to generate a voltage to wake up the IC chip.

Since the RFID technology uses radio communication, the electromagnetic wave for communication is subject to the environment where it is used and, for example, may be influenced by materials like metal and/or water adjacent to the ID tag. For instance, when the object to be identified is a metal or a beverage PET bottle, strength of the electric field of the electromagnetic wave reaching the ID tag attached to the object may be reduced. This is because (a) the electric field strength normally becomes small in the vicinity of metal, (b) the propagation speed and the apparent wavelength of the electromagnetic wave in water become small since water has a large relative permittivity, and (c) the dielectric loss is large. As a result, it is possible that the IC, or IC chip, does not wake up and radio communication itself becomes impossible. Moreover, even if the IC wakes up, there is a chance where the reader/writer cannot read or write the necessary ID information because the operation of the IC is not stable.

Furthermore, the IC chip and the antenna composing the ID tag are weak against external stress (pressure, shock, and temperature change) and are easily damaged. For instance, in an environment in which a construction machine (generator, pump, and compressor, etc.) is used, there is a possibility that an ID tag attached to the machine becomes deteriorated or damaged by shock and rapid temperature changes, etc. In addition, when a machine is used in water, there is a possibility that transmission and reception of RFID is not available to begin with, even if an ID tag is attached to the machine, because the machine and the ID tag are both submerged in water.

Japanese Unexamined Patent Publication (JP-A) No. 2002-196634 and No. 11-102424. JP-A No. 2003-196634 discloses a technology in which an ID tag is covered with a cover ring composed of a metal in order to improve the mechanical strength of the ID tag. JP-A No. 11-102424 discloses a technology in which a buffer layer composed of a gel state resin is provided on the substrate in the ID tag package in order to relieve the external stress.

However, in these patent publications, reduction of energy of the electromagnetic wave due to influence of adjacent metal or water was not addressed. In other words, measures to prevent energy reduction of electromagnetic wave in the presence of metal or water are not mentioned. Neither a RFID device nor system usable in water, nor a RFID device that may mitigate the external stress in such an environment, is disclosed.

### BRIEF DESCRIPTION OF THE DRAWINGS

FIG. 1 is a schematic view illustrating an RFID system of the present invention;

FIG. 2 is a cross-sectional view illustrating an embodiment (spherical shape) of an ID tag package of the present invention;

FIG. 3 is a plan view illustrating an ID tag of the present invention;

FIG. 4 is a cross-sectional view illustrating an embodiment (oval spherical shape) of an ID tag package of the present invention;

FIG. 5 is a cross-sectional view illustrating an embodiment (polyhedral shape) of an ID tag package of the present invention;

FIG. 6 is a cross-sectional view illustrating an embodiment (multi-layer structure) of an ID tag package of the present invention; and

FIG. 7 is a cross-sectional view illustrating an embodiment (with hook) of an ID tag package of the present invention.

Numerals and/or symbols used in above figures are briefly explained below.
10, 46: object
12: host computer (PC)
14: reader/writer
16, 18: electromagnetic wave
20, 40: ID tag package
22: ID tag
24: structure
26: IC chip
28: antenna
30: ceramics layer
32: rubber layer
34: foamed resin layer
42: hook for attachment of cable
44: cable
48: liquid (water)

### SUMMARY OF EMBODIMENTS OF THE INVENTION

Embodiments of the present invention provide an ID tag package for RFID which can realize good radio communication regardless of the existence of external metal or water and which, at the same time, is strong enough to endure external stress even under poor usage environment. Embodiments of the present invention also provide an RFID system using the ID tag package.

It is the characteristics of the ID tag package and the RFID system using the package of the present invention that (a) a structure covering the ID tag for the RFID has the thickness necessary for reducing the attenuation of the electromagnetic wave arising at least from existence of external metal or water, and that (b) the structure contains an elastic layer enabling to reduce the external stress.

Since the ID tag package and the RFID system using the package of the present invention have the above-described characteristics (a) and (b), good radio communication can be realized regardless of the existence of external metal or water, and at the same time, the ID tag package is strong enough to endure external stress. The ID tag package of the present invention enables good transmission and reception of RFID without paying particular attentions or giving special considerations to the materials of an object to be identified or the way of loading the object, which were conventionally deemed to be necessary. The ID tag package in the invention is highly enduring regardless of the utilization environment.

### DETAILED DESCRIPTION OF EMBODIMENTS OF THE INVENTION

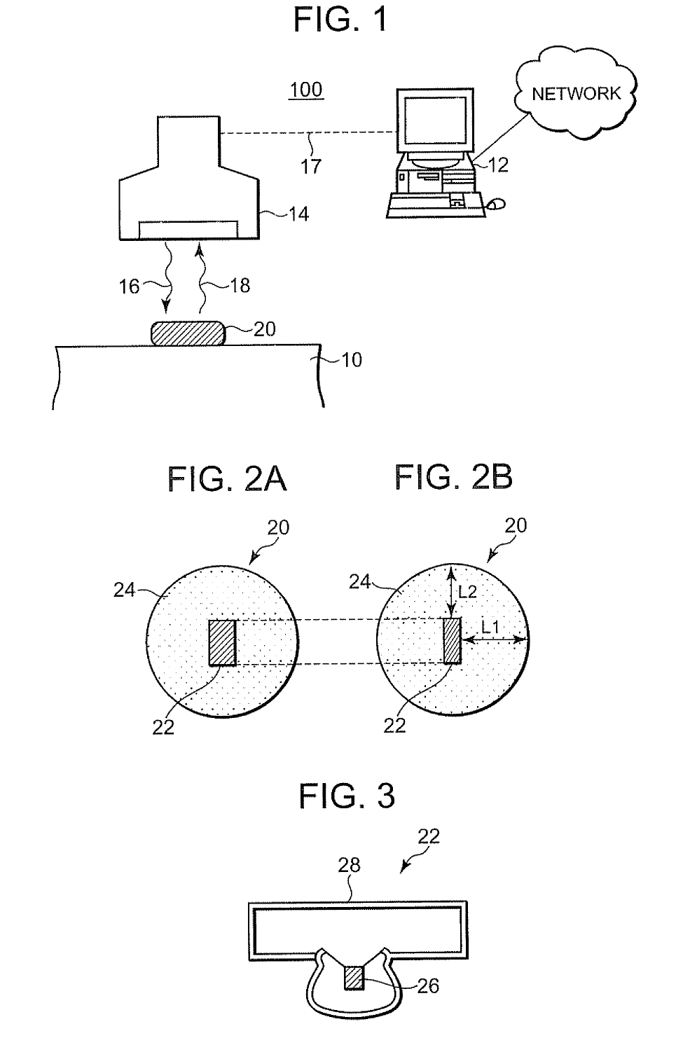

An ID tag package and a RFID system using the ID tag package according to embodiments of the present invention will be explained below with reference to the accompanying drawings. FIG. 1 is a schematic view illustrating a RFID system 100 in accordance with embodiments of the present invention. An electromagnetic wave 16 is sent from a reader/writer (reader and/or writer) 14 to an ID tag package 20 which is attached to the surface of an object 10 to be identified. The ID tag package 20 is woken up by the energy of the electromagnetic wave 16 and an electromagnetic wave 18 for reply is returned to the reader/writer 14. According to this intercommunication, the reader/writer 14 can write information into the ID tag package 20, and updated ID information can be read from the ID tag package 20. Frequency of the electromagnetic wave used for communication is low frequency (for example, 125 kHz), high frequency (for example, 13.56 MHz), or Ultra-High frequency (for example, 2.45 GHz), etc. The reader/writer 14 stores the read ID information in a memory arranged therein.

Moreover, the reader/writer 14 communicates with a personal computer (PC) 12, etc. for administration through wired and/or wireless network 17 and sends the ID information to the PC 12. The PC 12 stores the ID information sent from the reader/writer 14 and manages it. In the case of a small reader/writer, it is possible to connect the reader/writer directly with the PC 12 using an USB connector, etc. Moreover, the PC 12 can be connected with a central host computer and another client's PC through a communication network. As part of the ID information, both conventional simple identification information such as the product number, etc., and other “non-conventional” traceability information such as the location of the product and the utilization history, etc. are included. Information such as stock in the factory and stock in a distribution channel, etc. can be monitored in real time by managing the information. As a result, it becomes possible to plan a decrease in the amount of stock or a reduction in the turnover of inventory, maintain the freshness of fresh food, or improve the efficiency of callback operations.

FIG. 2 is a view illustrating an embodiment of the ID tag package 20 of the present invention. FIG. 2A is a cross-sectional view from the front of the ID tag package 20. FIG. 2B is a cross-sectional view from the side of the ID tag package 20. The ID tag package 20 comprises an ID tag 22 and a spherical shaped structure 24. Structure 24 may also be referred to hereinafter as enclosure 24. The ID tag 22 is placed at the center of the structure 24. The ID tag 22 has a plate-shaped appearance.

FIG. 3 is a plan view illustrating an example of the ID tag 22. The ID tag 22 comprises an IC chip 26 and an antenna 28 for radio communication. The IC chip 26 includes an arithmetic part and a memory (not shown in the figure), etc. inside thereof. The ID information is stored in the memory. The antenna 28 in FIG. 3 is of a folded dipole type. However, the present invention is not limited in this respect. For example, the shape of the antenna may be of other type.

In the ID tag package 20 in FIG. 2, the ID tag 22 is placed at substantially the center of the spherical shaped structure or enclosure 24. The distances L1 and L2, as illustrated in FIG. 2B, between the surface of the ID tag 22 and the surface of the structure 24 are substantially the same. In other words, almost distances from any point of the surface of the ID tag package 20 to the ID tag 22 are maintained almost the same for an electromagnet wave to reach, or being irradiated from, the ID tag package 20 from any directions. For example, if the ID tag package 20 is attached to a metal or a container holding water, the ID tag 22 is maintained at least at constant distances L1 and L2 from the metal or the water. As a result, it is achieved in reducing influence or attenuation of the electromagnetic wave arising from the existence of metal or water. Specifically, it is more effective when a microwave is used as the electromagnetic wave.

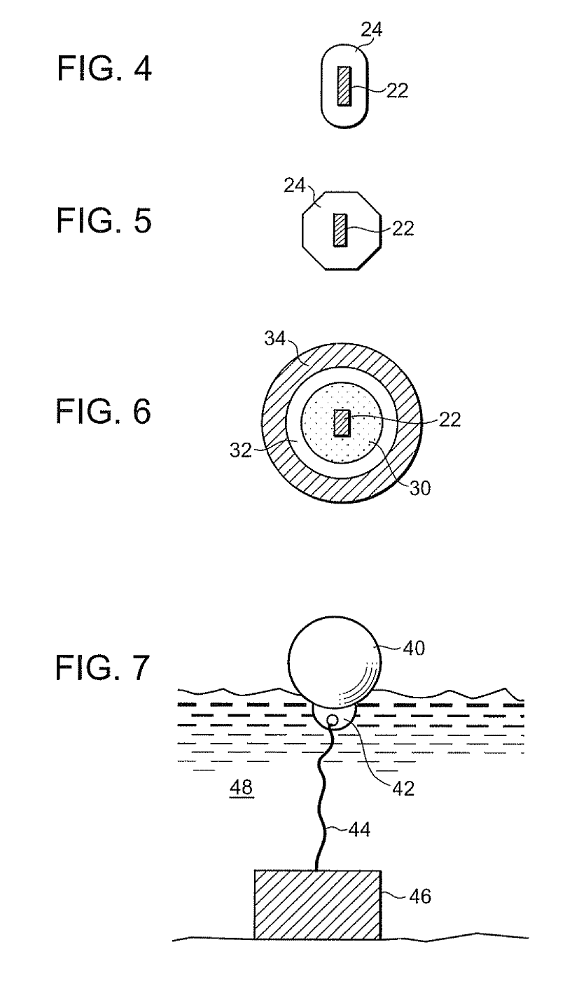

As to the shape of structure or enclosure 24, according to embodiments of the present invention, a spherical shape shown in FIG. 2 may be preferable from the viewpoint of maintaining an almost constant distance in any directions from the whole surface of the ID tag 22. However, so long as a distance longer than a pre-defined length is maintained and that distance is also sufficient for waking up the ID tag 22, the shape of the structure or enclosure 24 may take other shapes or forms, such as an oval spherical shape shown in FIG. 4 or a polyhedral shape shown in FIG. 5. Herein, both FIGS. 4 and 5 are cross-sectional views seen from the front. Moreover, in order to make the installation on the object to be identified easy, according to one embodiment of the present invention, one section or segment of the structure may be made flat (attachment surface).

The structure or enclosure 24 shall be maintained at a minimum thickness to ensure that sufficient energy of the electromagnetic wave may reach and wake up the ID tag during communication. The thickness may be decided depending on position of the reader/writer, the kind of electromagnetic wave (frequency) used, and the wake-up energy (electric field strength) of the IC in the ID tag. For example, the thickness is decided so as to obtain sufficient electric field strength for waking up the IC based upon experiments and simulations under the conditions in which metal or water is placed nearby. For instance, according to an experiment using 2.45 GHz band RFID system, the distance between the metallic plate and the ID tag, that is, the thickness of the structure, is required to be 2.5 cm or more in order to obtain 144 (dBuV/m) or more of electric field strength for waking up. In addition, the thickness of the structure should be made thick in accordance with the environment where the RFID is to be used, in order to improve endurance against external stress.

Material of the structure 24 is preferably an elastic material which can mitigate (reduce) the stress from the outside. For instance, the material of the structure 24 may be selected from any one or the combination of rubber, plastic, a polymeric material such as polyethylene or Teflon, an animal or plant fiber, a synthetic fiber, and a foamed resin. When selecting the material, relative permittivity of the material (for instance, air: 1.0, rubber: 3.0, Teflon: 2.1) and the dielectric loss (or dielectric loss tangent: tan δ) shall also be considered. Herein, the dielectric loss means a phenomenon where the vibration of a dipole in a dielectric cannot follow the electric field due to electromagnetic field, a shift (something similar to friction) is generated giving rise to a loss of the electromagnetic energy as heat. Materials having small dielectric loss are preferable for the structure. For instance, alumina, polyethylene, and Teflon, etc. are all materials having a small dielectric loss.

Since the wavelength of the electromagnetic wave becomes shorter (1/(εr)^{(1/2)} in a material having high relative permittivity (εr) in the case of an RFID which is resonated by the length of the antenna (element length), the size of the antenna can be made smaller. As a result, the ID tag can be minimized. Herein, high relative permittivity means a value from 5 to 10 and preferably above 10. In the case of a material having an extremely high relative permittivity like water (relative permittivity: 81), wavelength of the electromagnetic wave may become too short to obtain sufficient energy even while resonating when the length of the antenna (effective aperture size) is made small. In addition, dielectric (absorption) loss is also large in water.

It is not necessary that the structure is made of a single material or single type of material. According to embodiments of the present invention, structure or enclosure 24 may be made of one or more different materials. FIG. 6 is a cross-sectional view illustrating an example of the structure composed of a plurality of layers. The structure (package) shown in FIG. 6 may be composed of a ceramic layer 30 having high relative permittivity (for instance, alumina: 9.5), a rubber layer 32, a foamed resin layer 34, in order for example, from the side close to the ID tag 22. There is an advantage that the ceramic (alumina) has a small dielectric loss. In general, ceramics have poor mechanical strength (tensile strength, impact resistance, thermal shock, etc.) but the external stress can be mitigated (absorbed) by covering it with a rubber layer and a foamed resin layer. There may be no limitation on the number of layers that may be applied to structure 24. An air layer may also be provided as an air cushion. The combination of materials may also be selected arbitrarily. For instance, elastic material layers can be selected to make an elastic modulus greater from the inside toward the outside. Additionally, in consideration of possible use under high temperatures, the outermost layer of the structure may be composed of a fireproof and heat-resistant material, for instance, a firebrick, and a heat-resistant composite plastic layer. Accordingly, a temperature increase inside of the ID tag is suppressed, resulting in it being possible to utilize the ID tag under high temperatures.

FIG. 7 is a schematic view illustrating an example of an ID tag package to perform RFID of an object put in liquid such as, for example, water. A hook or fitting 42 is provided at the surface of the spherical shaped ID tag package 40 for attachment of a connecting cable 44. One end of cable 44 is connected with an object 46 in liquid 48. Structure of ID tag package 40 is composed of a material which is light and floats on the liquid. An air layer may be included in the structure to make it lighter. At least the surface of the structure is covered with a layer of material which is waterproof and has chemical resistance. By applying ID tag package 40 shown in FIG. 7, ID information of a machine used in the liquid, for instance, a submerged pump may be obtained from remote sites. A person skilled in the art will appreciate that the present invention is not limited for use in liquid. For example, embodiments of the present invention may be applied in situations where an object is located far from the reader/writer.

What is claimed is:

1. An identification (ID) tag package comprising:
an ID tag including an IC chip and an antenna adapted for radio communication; and
a structure enclosing said ID tag, wherein said structure has a thickness measured from a surface thereof to said ID tag, said thickness being sufficient in reducing influence caused by adjacent metal or water to an electromagnetic wave communicating with said ID tag, and contains an elastic layer enabling reduction of external stresses to said ID tag.

2. The ID tag package according to claim 1, wherein the surface of said structure has a substantially constant distance from a surface of said ID tag.

3. The ID tag package according to claim 1, wherein the thickness of said structure is adapted such that an energy of the electromagnetic wave communicating with said ID tag is at least greater than an energy necessary for waking up said ID tag.

4. The ID tag package according to claim 1, wherein said structure has a shape selected from the group consisting of an oval spherical shape, a spherical shape, and a polyhedral shape.

5. The ID tag package according to claim 1, wherein said structure comprises a plurality of layers and includes a layer of material having high relative permittivity.

6. The ID tag package according to claim 5, wherein said layer of high relative permittivity comprises ceramics.

7. The ID tag package according to claim 5, wherein one of said plurality of layers is an air layer.

8. The ID tag package according to claim 1, wherein said elastic layer is selected from a group consisting of rubber, plastic, polymeric material, fiber of animal or plant, synthetic fiber, and foamed resin.

9. The ID tag package according to claim 1, wherein the surface of said structure is covered with a layer of heat-resistant material.

10. The ID tag package according to claim 1, wherein said structure has a fitting for attachment of a cable from an object to be identified by said ID tag.

11. A Radio Frequency Identification (RFID) system comprising:
an ID tag package;
a reader/writer adapted to communicate by radio with the ID tag package; and
a host computer adapted to communicate with the reader/writer,
wherein said ID tag package comprising:
an ID tag including an IC chip and an antenna for radio communication; and
a structure covering said ID tag, said structure having a thickness necessary for reducing attenuation, caused by existence of metal or water external to said ID tag, of an electromagnetic wave communicating with said ID tag and containing an elastic layer enabling reduction of external stresses to said ID tag.
